(19) United States
(12) Patent Application Publication
(10) Pub. No.: US 2026/0229063 A1
(43) Pub. Date: Aug. 6, 2026

(54) INFORMATION PROCESSING APPARATUS, INFORMATION PROCESSING METHOD, AND NON-TRANSITORY RECORDING MEDIUM

(71) Applicant: NEC Corporation, Tokyo (JP)

(72) Inventor: Ryuichi AKASHI, Tokyo (JP)

(73) Assignee: NEC Corporation, Tokyo (JP)

(21) Appl. No.: 19/145,996

(22) PCT Filed: Mar. 22, 2023
(86) PCT No.: PCT/JP2023/011181

§ 371 Date: Jul. 7, 2025

(51) Int. Cl. G06V 40/40; G06V 10/75; G06V 10/776; G06V 40/18

(52) U.S. Cl. CPC G06V 40/40; G06V 10/75; G06V 10/776; G06V 40/193; G06V 40/197

(57) ABSTRACT

An information processing apparatus including: a transformation unit that transforms biometric information to generate transformed biometric information; and an estimation unit that estimates a false acceptance ratio of incorrectly accepting imposters in case the biometric information is used for biometric recognition, based on the biometric information and the transformed biometric information.

### TECHNICAL FIELD

This disclosure relates to the technical field of information processing apparatus, information processing methods, and recording media.

### BACKGROUND ART

Patent Literature 1 describes a wearable system is described that receives a plurality of first iris images from an iris imaging apparatus, generates a plurality of first iris codes corresponding to the plurality of first iris images, generates a distribution metric corresponding to iris cell locations, generates a first composite iris code using the distribution metric, and generates a first matching value using the first composite iris code and a first stored iris code.

Patent Literature 2 describes a technology for acquiring biometric information for registration, referring to a storage means that stores registered biometric information linked to groups, calculating the degree of similarity between the biometric information for registration and the registered biometric information, selecting a group to link to the biometric information for registration based on the calculated degree of similarity, and linking the selected group to the biometric information for registration and storing it in the storage means.

Patent Literature 3 describes a technology for improving the accuracy of authentication based on biometric information of the eyes of a user by authenticating biometric information identified from each of images of the user's eyes taken from different eye directions based on reference images of the user's eyes for each eye direction, and combining the authentication results.

Patent Literature 4 describes a technology for acquiring biometric information from the left and right sides of a pair of biometric parts on the left and right sides of the body, generating biometric information feature used for comparison from the left and right biometric information, generating similarity feature data used for calculating the similarity between the left and right biometric information from the left and right biometric information, and comparing the similarity feature data to authenticate the identity of the user, generating matching feature data for comparison, generating similarity feature data for calculating the similarity between the left and right biometric information, comparing the similarity feature data to calculate a similarity score indicating the similarity between the left and right biometric information, associating the left and right matching feature data with the similarity score and registering them in a registration database, and the left and right verification feature data generated from the biometric information at the time of authentication, and using the similarity scores obtained by comparing the left and right verification scores, the similarity scores in the registration database, and the similarity feature between the left and right at the time of authentication to determine whether authentication is successful or not.

Patent Literature 5 describes a technology for acquiring biometric information by a biometric information acquisition unit, acquiring first and second registration information by a registration information acquisition unit, generating a comparison score from the first registration information and the biometric information by an authentication unit, outputting an authentication result by comparing the comparison score with a threshold value, generating a comparison score for each of the two combinations of the biometric information that passed the authentication and the first and second registration information by a comparison evaluation unit, evaluating the comparison scores, generating evaluation results, and, when the biometric information can be considered good quality second registered information, using a replacement unit to register the biometric information as new second registered information, thereby improving authentication accuracy in the authentication process.

Patent Literature 6 describes a method for improving the accuracy of authentication in an authentication process for a person by registering multiple iris codes for each registered person in an iris database together with pupil diameter and iris diameter ratio, and, at the time of authentication, the iris code is obtained from the photographed iris image by extraction, the pupil diameter and iris diameter ratio are calculated, and the ratio on the registration side is compared with the ratio at the time of authentication to select the appropriate iris code from the iris database as the collation target and perform authentication.

### CITATION LIST

### Patent Literature

Patent Literature 1: JP2022-105185A

Patent Literature 2: JP2017-215894A

Patent Literature 3: WO2016/088415A

Patent Literature 4: JP2016-099880A

Patent Literature 5: WO2012/131899A

Patent Literature 6: JP2004-167227A

### SUMMARY

It is an example object of this disclosure to provide an information processing apparatus, an information processing method, and a recording medium that are intended to improve the techniques/technologies disclosed in Citation List.

### Solution to Problem

An information processing apparatus according to an example aspect includes: a transformation unit that transforms biometric information to generate transformed biometric information; and an estimation unit that estimates a false acceptance ratio of incorrectly accepting imposters in case the biometric information is used for biometric recognition, based on the biometric information and the transformed biometric information.

An information processing method according to an example aspect includes: transforming biometric information to generate transformed biometric information; and estimating a false acceptance ratio of incorrectly accepting imposters in case the biometric information is used for biometric recognition, based on the biometric information and the transformed biometric information.

A recording medium according to an example aspect is a recording medium on which a computer program that allows a computer to execute an information processing method is recorded, the information processing method including: transforming biometric information to generate transformed biometric information; and estimating a false acceptance ratio of incorrectly accepting imposters in case the biometric information is used for biometric recognition, based on the biometric information and the transformed biometric information.

### BRIEF DESCRIPTION OF DRAWINGS

FIG. 1 is a block diagram illustrating a configuration of an information processing apparatus according to this disclosure.

FIG. 2 is a block diagram illustrating a configuration of an information processing apparatus according to this disclosure.

FIG. 3 is a flowchart illustrating a flow of an information processing operation of the information processing apparatus according to this disclosure.

FIG. 4 is a block diagram illustrating a configuration of an information processing apparatus according to this disclosure.

FIG. 5 is a diagram illustrating an overview of an information processing operation of an information processing apparatus according to this disclosure.

FIG. 6 is a block diagram illustrating a configuration of an information processing apparatus according to this disclosure.

FIG. 7 is a flowchart illustrating a flow of an information processing operation of the information processing apparatus according to this disclosure.

FIG. 8 is a block diagram illustrating a configuration of an information processing apparatus according to this disclosure.

FIG. 9 is a block diagram illustrating a configuration of an information processing apparatus according to this disclosure.

FIG. 10 is a flowchart illustrating a flow of an information processing operation of the information processing apparatus according to this disclosure.

FIG. 11 is a diagram illustrating a matching score distribution generated by an information processing apparatus according to this disclosure.

FIG. 12 is a block diagram illustrating a configuration of an information processing apparatus according to this disclosure.

FIG. 13 is a block diagram illustrating a configuration of an information processing apparatus according to this disclosure.

### DESCRIPTION OF EXAMPLE EMBODIMENTS

The following describes embodiments of the information processing apparatus, the information processing method, and the recording medium with reference to the drawings.

### 1: First Example Embodiment

A first embodiment of an information processing apparatus, information processing method, and recording medium is described. The first embodiment of the information processing apparatus, information processing method, and recording medium will be described below using an information processing apparatus 1 to which the first embodiment of the information processing apparatus, information processing method, and recording medium is applied.

### [1-1: Configuration of the Information Processing Apparatus 1]

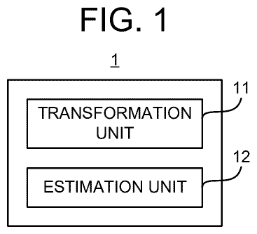

FIG. 1 is a block diagram showing the configuration of the information processing apparatus 1 according to the first embodiment. As shown in FIG. 1, the information processing apparatus 1 includes a transformation unit 11 and an estimation unit 12. The transformation unit 11 generates transformed biometric information by transforming biometric information. The estimation unit 12 estimates a false acceptance ratio, which is the ratio of incorrectly accepting imposters in case the biometric information is used for biometric recognition, based on the biometric information and the transformed biometric information.

### [1-2: Technical Effect of the Information Processing Apparatus 1]

The information processing apparatus 1 according to the first embodiment can estimate the ratio of incorrectly accepting the imposters in case the biometric information is used for the biometric recognition from information that can be acquired based on the biometric information.

### 2: Second Example Embodiment

Next, a second embodiment of the information processing apparatus, information processing method, and recording medium will be described. The second embodiment of the information processing apparatus, information processing method, and recording medium will be described using an information processing apparatus 2 to which the second embodiment of the information processing apparatus, information processing method, and recording medium is applied.

### [2-1: Configuration of the Information Processing Apparatus 2]

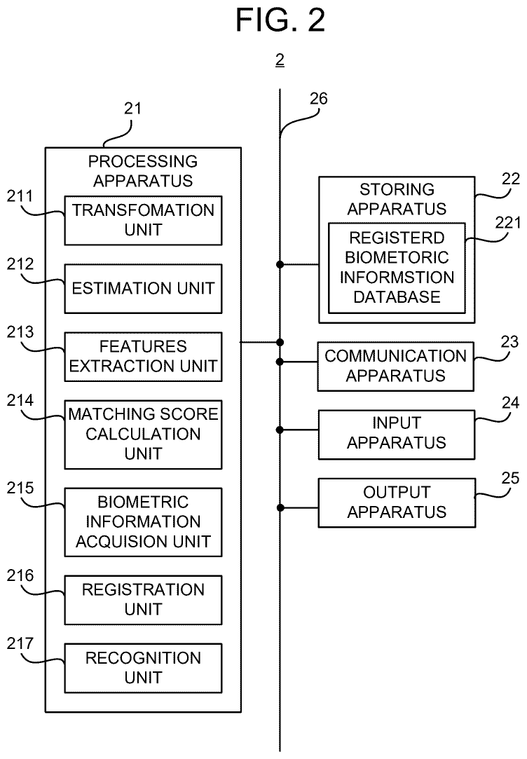

FIG. 2 is a block diagram showing the configuration of the information processing apparatus 2 according to the second embodiment. As shown in FIG. 2, the information processing apparatus 2 includes a processing apparatus 21 and a storing apparatus 22. Furthermore, the information processing apparatus 2 may include a communication apparatus 23, an input apparatus 24, and an output apparatus 25. However, the information processing apparatus 2 may not include at least one of the communication apparatus 23, the input apparatus 24, and the output apparatus 25. The processing apparatus 21, the storing apparatus 22, the communication apparatus 23, the input apparatus 24, and the output apparatus 25 may be connected via a data bus 26.

The processing apparatus 21 may be, for example, a CPU (Central Processing Unit), a GPU (Graphics Processing Unit), and/or an FPGA (Field Programmable Gate Array). The processing apparatus 21 reads a computer program. For example, the processing apparatus 21 may read a computer program stored in the storing apparatus 22. For example, the processing apparatus 21 may read a computer program stored in a computer-readable and non-temporary recording medium using a recording medium reading apparatus (e.g., the input apparatus 24 described later) provided in the information processing apparatus 2. The processing apparatus 21 may obtain (i.e., download or load) a computer program from an unillustrated apparatus located outside the information processing apparatus 2 via the communication apparatus 23 (or other communication apparatus). The processing apparatus 21 executes the loaded computer program. As a result, logical function blocks for executing operations to be performed by the information processing apparatus 2 are realized within the processing apparatus 21. In other words, the processing apparatus 21 functions as a controller capable of realizing logical functional blocks for executing the operations (i.e., processing) that the information processing apparatus 2 should perform.

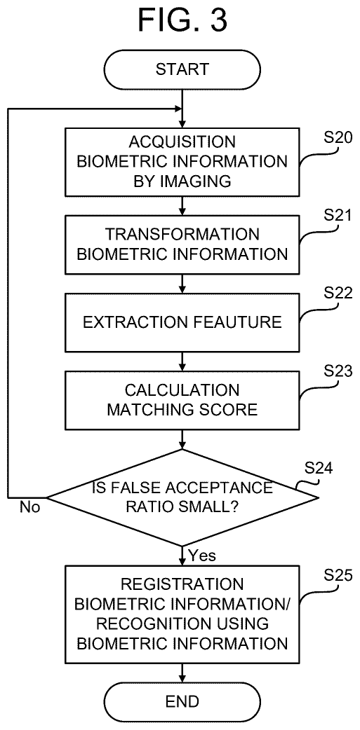

FIG. 2 shows an example of logical functional blocks realized within the processing apparatus 21 for executing information processing operations. As shown in FIG. 2, the processing apparatus 21 includes a transformation unit 211, which is a specific example of the “transformation unit” described in the Supplementary Note described later, an estimation unit 212, which is a specific example of the “estimation unit” described in the Supplementary Note described later, a features extraction unit 213, a matching score calculation unit 214, a biometric information acquisition unit 215, a registration unit 216, and a recognition unit 217. However, any one or more of the features extraction unit 213, the matching score calculation unit 214, the biometric information acquisition unit 215, the registration unit 216, and the recognition unit 217 may be omitted from the processing apparatus 21. The details of the operations of the transformation unit 211, the estimation unit 212, the features extraction unit 213, the matching score calculation unit 214, the biometric information acquisition unit 215, the registration unit 216, and the recognition unit 217 will be explained later with reference to FIG. 3.

The storing apparatus 22 is capable of storing desired data. For example, the storing apparatus 22 may temporarily store a computer program executed by the processing apparatus 21. The storing apparatus 22 may temporarily store data that the processing apparatus 21 temporarily uses in case of executing a computer program. The storing apparatus 22 may store data that the information processing apparatus 2 stores long-term. Note that the storing apparatus 22 may be RAM (Random Access Memory), ROM (Read Only Memory), a hard disk apparatus, an optical magnetic disk apparatus, an SSD (Solid State Drive), and a disk array apparatus. In other words, the storing apparatus 22 may include a non-temporary recording medium. The storing apparatus 22 may implement a registered biometric information database 221.

The communication apparatus 23 is capable of communicating with an external apparatus of the information processing apparatus 2 via an unillustrated communication network. The communication apparatus 23 may be a communication interface based on standards such as Ethernet (registered trademark), Wi-Fi (registered trademark), Bluetooth (registered trademark), or USB (Universal Serial Bus).

The input apparatus 24 is an apparatus that accepts information input to the information processing apparatus 2 from outside the information processing apparatus 2. For example, the input apparatus 24 may include an operation apparatus (e.g., at least one of a keyboard, a mouse, and a touch panel) that can be operated by an operator of the information processing apparatus 2. For example, the input apparatus 24 may include a reading apparatus that can read information recorded as data on a recording medium that can be attached to the information processing apparatus 2.

The output apparatus 25 is an apparatus that outputs information to the outside of the information processing apparatus 2. For example, the output apparatus 25 may output information as images. In other words, the output apparatus 25 may include a display device (a so-called display) capable of displaying images indicating the information to be output. For example, the output apparatus 25 may output information as sound. In other words, the output apparatus 25 may include a sound apparatus (i.e., a speaker) capable of outputting sound. Furthermore, for example, the output apparatus 25 may output information onto paper. In other words, the output apparatus 25 may include a printing apparatus (i.e., a printer) capable of printing desired information onto paper.

### [2-2: Information Processing Operations Performed by the Information Processing Apparatus 2]

The information processing apparatus 2 according to this embodiment performs the biometric recognition using the biometric information. In this embodiment, the biometric information includes living body images for use in the biometric recognition. The living body images may include face images, iris images, fingerprint images, etc. In addition, in this embodiment, the biometric information includes features extracted from the living body images for use in the biometric recognition. The information processing apparatus 2 performs an operation of registering the biometric information acquired by the biometric information acquisition unit 215 to the registered biometric information database 221 by the registration unit 216 and a biometric recognition operation of the biometric information acquired by the biometric information acquisition unit 215 and the biometric information registered in the registered biometric information database 221 by the recognition unit 217.

In the biometric recognition operation, first, the features extraction unit 213 extracts the features from the living body image acquired by the biometric information acquisition unit 215 or from a transformed living body image transformed by the transformation unit 211. Next, the matching score calculation unit 214 calculates a recognition score based on the features. The recognition unit 217 determines the success or failure of the biometric recognition based on a comparison of the recognition score and a recognition score threshold value. The recognition score threshold value may be set according to the characteristics of the features extraction unit 213 and the matching score calculation unit 214, the purpose of using the biometric recognition, the environment in which the biometric recognition is used, and other factors. The score used for recognition is called the recognition score, which is calculated from the features extracted from the image and the features registered in the registered biometric information database. In addition, the score used for quality determination is called the matching score, which is calculated from the features extracted from the living body image acquired and the features extracted from the transformed living body image. The scores that form the score distribution used for the quality determination, which will be explained in another embodiment, is also called the matching score. The recognition score and the matching score are calculated by the same recognition means.

In this embodiment, the information processing apparatus 2 evaluates whether the quality of the biometric information satisfies criteria for registration in the registered biometric information database 221 before the biometric information registration operation. In addition, the information processing apparatus 2 evaluates whether the quality of the biometric information satisfies criteria for the biometric recognition before performing the biometric recognition operation using the biometric information. In other words, the information processing apparatus 2 can perform the biometric recognition using registered biometric information of a predetermined quality or higher and biometric information of a predetermined quality or higher. Specifically, in this embodiment, biometric information of a predetermined quality or higher is biometric information with a low false acceptance ratio in case used for the biometric recognition.

The information processing apparatus 2 performs an estimation operation of the false acceptance ratio to estimate the false acceptance ratio that will cause the system to incorrectly accept the imposters in case the biometric information acquired by the biometric information acquisition unit 215 is used for the biometric recognition. The information processing apparatus 2 performs the estimation operation of false acceptance ratio using the features extraction unit 213 and the matching score calculation unit 214 used by the recognition unit 217 in the biometric recognition operation.

Referring to FIG. 3, the flow of the estimation operation of false acceptance ratio performed by the information processing apparatus 2 is explained. FIG. 3 is a flowchart showing the estimation operation of false acceptance ratio performed by the information processing apparatus 2.

As shown in FIG. 3, the biometric information acquisition unit 215 acquires a living body image acquired by imaging (step S20). The biometric information acquisition unit 215 may acquire the living body image acquired by imaging with a camera. The biometric information may be the living body image acquired by imaging for registration. Alternatively, the biometric information may be the living body image acquired by imaging for biometric recognition.

The transformation unit 211 generates the transformed biometric information by transforming the biometric information (step S21). The transformation unit 211 may generate the transformed living body image by transforming the living body image. In case the biometric information is transformed, the transformed biometric information generated has a different feature from the biometric information before transformation. Therefore, in case the living body image is transformed, the transformed living body image generated becomes a living body image with a different feature from the original living body image before transformation. In other words, the transformation unit 211 can be rephrased as generating the transformed living body image with a feature different from the original living body image, belonging to the different individuals. The transformation of the transformed living body image will be described in other embodiments.

The features extraction unit 213 extracts the features from the biometric information and extracts transformed features from the transformed biometric information (step S22). The features extraction unit 213 may extract the features from the living body image and the transformed features from the transformed living body image.

The matching score calculation unit 214 calculates the matching score based on the features and the transformed features (step S23). The matching score calculation unit 214 calculates the matching score as a numerical value for determining whether the biometric information is from a same individual. The matching score increases in case the possibility that the biometric information is from the same individual is high, and decreases in case the possibility that the biometric information is from the same individual is low. However, in case of using a biometric recognition means that has the characteristic that in case a possibility that the biometric information is from the same individual is high, a matching score will decrease, and in case a possibility that the biometric information is from the same individual is low, the matching score will increase, the magnitude relationship between the possibility that the biometric information is of the same individual and the matching score will be the opposite of that described above. Hereinafter, a recognition means in which the matching score becomes larger in case it is highly likely that the biometric information is from the same individual will be explained as an example. A matching score may be calculated in the same way as the recognition score calculated during recognition.

In case a quality of the biometric information is poor, matching score between biometric information having the same type of poor quality is often high even if the biometric information belongs to the different individuals. In other words, using poor quality biometric information increases the false acceptance ratio of incorrectly accepting the imposters. Poor quality includes cases such as focus blur, motion blur, pupil dilation, low contrast, and sensor noise.

As mentioned above, the transformed biometric information is information that has lost the feature of the owner of the biometric information before transformation. Therefore, the extracted the transformed features also loses the feature of their owner. In case the quality of biometric information is good, the matching score calculated based on the features and the transformed features often indicates a low possibility that the biometric information belongs to the same individual. In other words, the matching score tends to be small. On the other hand, in case the quality of the biometric information is poor, the matching score calculated based on the features and the transformed features may indicate a high possibility that the biometric information belongs to the same individual. In other words, the matching score may be large. From this, based on whether a matching score calculated from the biometric information and information from which feature has been removed is a numerical value indicating a possibility that the biometric information is from the same individual, it is possible to estimate the magnitude of the false acceptance ratio in case the biometric recognition is performed using the biometric information.

The estimation unit 212 estimates the false acceptance ratio based on the matching score (step S24). In case the matching score is a numerical value that is unlikely to be the biometric information of the same individual, the estimation unit 212 may estimate that the false acceptance ratio is small. In other words, since for information that has lost individuality due to transformation, the numerical value was calculated that indicates a low possibility that it is information of the same individual, it can be estimated that there is a low possibility that the imposters will be accepted in the biometric recognition using that biometric information. On the other hand, in case the matching score is a numerical value that is highly likely to be biometric information of the same individual, the estimation unit 212 may estimate that the false acceptance ratio is large. In other words, since for information that has lost individuality due to transformation, a numerical value was calculated that indicates a high possibility that it is information from same individual, it can be estimated that there is a high possibility that the imposters will be accepted in the biometric recognition using that biometric information. In other words, the estimation unit 212 determines whether the matching score is a numerical value indicating a low possibility that the biometric information is that from the same individual, or a numerical value indicating a high possibility that the matching score is calculated based on each piece of the biometric information of the same individual. The estimation unit 212 may set a threshold value for the matching score and estimate the false acceptance ratio by comparing the matching score with the threshold value. In this way, the estimation unit 212 can estimate the false acceptance ratio, which is the ratio of incorrectly accepting the imposters, based on the biometric information and the transformed biometric information. The threshold value for the matching score may be set based on the distribution of matching scores calculated by the matching score calculation unit 214 based on the features extracted by the features extraction unit 213. The distribution of matching scores will be explained in another embodiment.

In case the false acceptance ratio is small (step S24: Yes) and the biometric information for registration was acquired in step 20, the registration unit 216 registers the biometric information acquired in the registered biometric information database 221 (step S25-1). In case the false acceptance ratio is small (step S24: Yes) and the biometric information for recognition was acquired in step 20, the recognition unit 217 performs the biometric recognition using the biometric information acquired and the biometric information registered in the registered biometric information database 221 (step S25-2).

In case the false acceptance ratio is large (step S24: No), return to step S20 and capture the image to acquire the biometric information again.

The functions of the transformation unit 211, the estimation unit 212, the features extraction unit 213, and the matching score calculation unit 214 in this embodiment may be referred to as quality evaluation functions.

### [2-3: Technical Effects of the Information Processing Apparatus 2]

In case poor quality biometric information is included with the biometric information registered in the registration database and the biometric information to be authenticated, a possibility of incorrectly accepting the imposters may be high. In addition, even if individual is same individual, a possibility of incorrectly rejecting the same individual may be high. Thus, using poor quality biometric information for biometric recognition reduces the performance of the recognition system, such as its accuracy and usability. In particular, in case poor quality biometric information is registered in the registration database, the individual corresponding to that biometric information will always be authenticated with poor quality biometric information, which is a big problem.

In the second embodiment, the information processing apparatus 2 can control false acceptance of the imposters due to the quality of the living body image by using a matching score based on the living body image acquired and the transformed living body image. In other words, the information processing apparatus 2 determine, from a single image of a living body, whether quality of the single image is sufficient for use in the biometric recognition. Since the information processing apparatus 2 does not require reference to information registered in a database or the like, it is relatively easy to estimate the false acceptance ratio in case the living body images are used for the biometric recognition.

### 3: Third Example Embodiment

Next, the third embodiment of the information processing apparatus, information processing method, and recording medium will be described. In the following, the third embodiment of the information processing apparatus, information processing method, and recording medium will be described using an information processing apparatus 3 to which the third embodiment of the information processing apparatus, information processing method, and recording medium is applied.

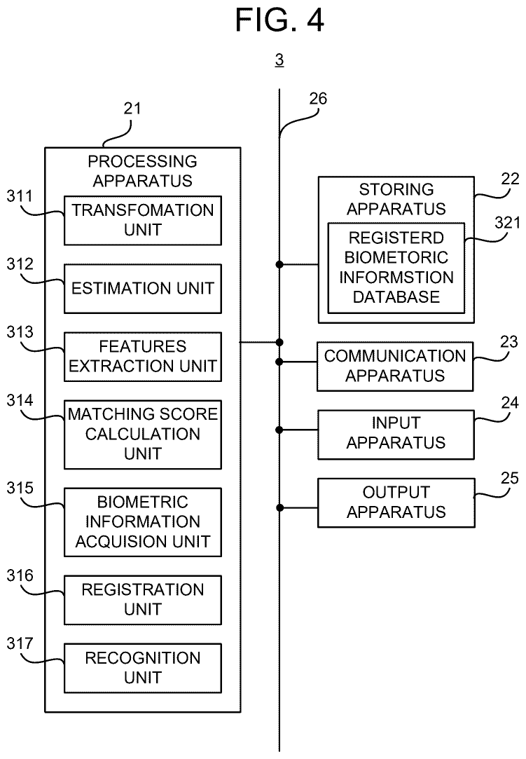

FIG. 4 is a block diagram showing the configuration of the information processing apparatus 3 according to the third embodiment. In the third embodiment, the operations of a transformation unit 311, an estimation unit 312, a features extraction unit 313, a matching score calculation unit 314, a biometric information acquisition unit 315, a registration unit 316, and a recognition unit 317 differ from those of the information processing apparatus 2 according to the second embodiment.

### [3-1: Information Processing Operations Performed by the Information Processing Apparatus 3]

Referring to FIG. 3, the flow of information processing operations performed by the information processing apparatus 3 will be described. In the third embodiment, the biometric information includes an iris image.

As shown in FIG. 3, the biometric information acquisition unit 315 acquires the iris image captured (step S20). The iris image acquired by the biometric information acquisition unit 315 may be an iris image captured for registration. Alternatively, the iris image acquired by the biometric information acquisition unit 315 may be an iris image captured for the biometric recognition.

The transformation unit 311 generates a transformed iris image by transforming the iris image (step S21).

### Example of Generating the Transformed Iris Image

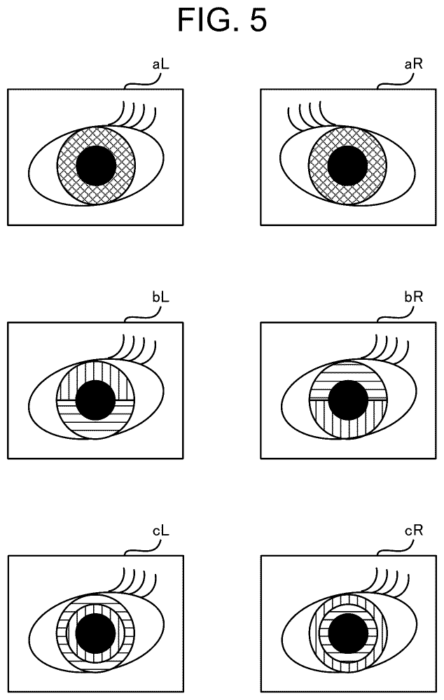

The transformation unit 311 may generate the transformed iris image by inverting the iris image. The approximate circular iris region of the iris image is referred to as an iris circle. The transformation unit 311 may generate the transformed iris image by inverting the iris circle of the iris image in any direction. In case the image aL shown in FIG. 5 is the original iris image that has not been transformed, the transformation unit 311 may generate the transformed iris image aR shown in FIG. 5 by inverting the left and right sides of the original iris image.

Additionally, the transformation unit 311 may generate the transformed iris image by dividing the iris circle of the iris image into partial regions using at least one of two or more radii of the iris circle and a circle sharing a center with the iris circle, and then changing positions of the partial regions. In other words, the transformation unit 311 may generate the transformed iris image by synthesizing the partial images.

The transformation unit 311 may divide the iris circle of the iris image into the partial regions using the diameter of the iris circle and generate the transformed iris image by changing the positions of the partial regions divided. Assume that the image bL shown in FIG. 5 is the original iris image that has not been transformed. In this case, for example, as shown in the image bL in FIG. 5, the transformation unit 311 may divide the iris circle into an upper region and a lower region based on the diameter of the iris circle. The transformation unit 311 may generate the transformed iris image bR illustrated in FIG. 5 by changing the position of the upper region of the iris circle in image bL illustrated in FIG. 5 to the lower side and changing the position of the lower region of the iris circle in image bL illustrated in FIG. 5 to the upper side.

The transformation unit 311 may divide the iris circle of the iris image into an inner region and an outer region by dividing the iris circle into regions on one side and the other side of the radius of the iris circle, and generate the transformed iris image by changing the positions of the partial regions divided. Alternatively, the transformation unit 311 may be rephrased as dividing the iris circle of the iris image into one side and the other side in the radial direction of the iris circle, and generating the transformed iris image by changing the positions of the partial regions divided. Assume that the image cL shown in FIG. 5 is the original iris image that has not been transformed. In this case, for example, as shown in the image cL in FIG. 5, the transformation unit 311 may divide the iris circle into an inner region and an outer region by using the circle that shares the center with the iris circle. The transformation unit 311 may generate the transformed iris image cR illustrated in FIG. 5 by changing the position of the inner region of the iris circle in the image cL illustrated in FIG. 5 to the outer side and changing the position of the outer region of the iris circle in the image cL illustrated in FIG. 5 to the inner side.

The features extraction unit 313 extracts iris features from the iris image and extracts the transformed features from the transformed iris image (step S22). The matching score calculation unit 314 calculates a matching score based on the iris features and the transformed iris features (step S23). The estimation unit 312 estimates the false acceptance ratio based on the matching score (step S24).

In case the false acceptance ratio is small (step S24: Yes) and the iris image for registration was acquired in step 20, the registration unit 316 registers the iris image acquired in a registered biometric information database 321 (step S25-1). In case the false acceptance ratio is small (step S24: Yes) and the iris image for recognition was acquired in step 20, the recognition unit 317 performs the iris recognition using the iris image acquired and the iris image registered in the registered biometric information database 321 (step S25-2).

In this embodiment, the case where the biometric information is the iris image is used as an example. In case the biometric information is a fingerprint image, the transformation unit 311 may perform the same transformation as the iris image described above. In case the biometric information is a face image, the transformation unit 311 may transform the face image by exchanging parts included in the face area, such as exchanging the left and right eyes or exchanging the left and right ears.

### [3-2: Technical Effects of the Information Processing Apparatus 3]

The information processing apparatus 3 according to the third embodiment can estimate the false acceptance ratio related to the iris recognition using the iris image in case of registering and authenticating iris images. The information processing apparatus 3 can guarantee the quality of iris images used for iris recognition.

Furthermore, the information processing apparatus 3 can efficiently transform the iris images. The information processing apparatus 3 can transform the iris information without losing the original information.

### 4: Fourth Example Embodiment

Next, the fourth embodiment of the information processing apparatus, information processing method, and recording medium will be described. In the following, the fourth embodiment of the information processing apparatus, information processing method, and recording medium will be described using an information processing apparatus 4 to which the fourth embodiment of the information processing apparatus, information processing method, and recording medium is applied.

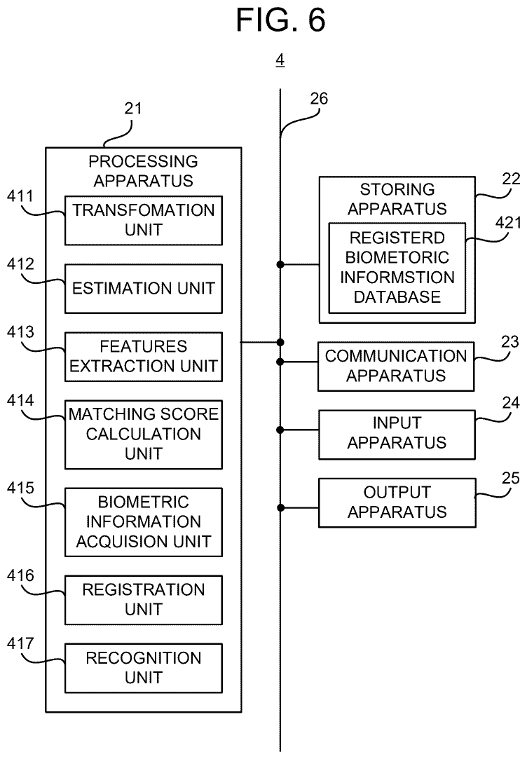

FIG. 6 is a block diagram showing the configuration of the fourth embodiment. The fourth embodiment differs from the second embodiment and the third embodiment in the operations of a transformation unit 411, an estimation unit 412, a features extraction unit 413, a matching score calculation unit 414, a biometric information acquisition unit 415, a registration unit 416, and a recognition unit 417.

### [4-1: Information Processing Operations Performed by the Information Processing Apparatus 4]

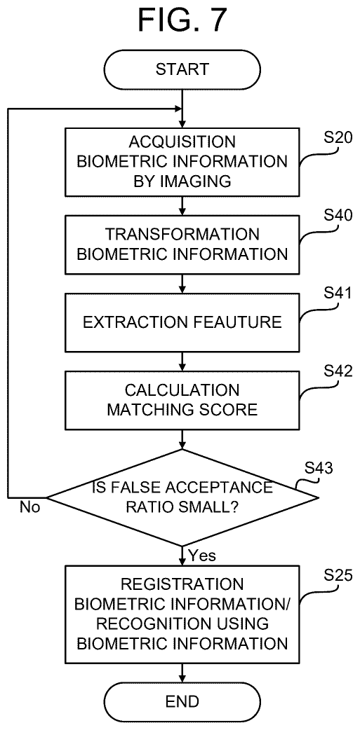

Referring to FIG. 7, the flow of information processing operations performed by the information processing apparatus 4 will be described. FIG. 7 is a flowchart showing the information processing operations performed by the information processing apparatus 4.

In the fourth embodiment, the biometric information includes the features extracted from the living body images. As shown in FIG. 7, the biometric information acquisition unit 415 acquires living body images that have been captured (step S20). The living body images may be images that can be used for the biometric recognition, such as face images, iris images, and fingerprint images. The living body images may be living body images that have been captured for registration. Alternatively, the living body images may be living body images that have been captured for the biometric recognition.

The features extraction unit 413 extracts the features from the living body images (step S40). The features extracted by the features extraction unit 413 from the living body images may include a correspondence relationship between coordinates within an image and feature information corresponding to the coordinates. The coordinates within the image may be polar coordinates.

The transformation unit 411 generates the transformed features by transforming the features (step S41). The transformation unit 411 may transform the features while maintaining the correspondence between the coordinates within the image and the feature information. The transformation of the features will be described in other embodiments. In case the features are transformed, the transformed features generated loses the individuality of the features of original before transformation. In other words, the transformation unit 411 can be rephrased as generating the transformed features that has feature belonging to a different individual.

The matching score calculation unit 414 calculates a matching score based on the features and the transformed features (step S42).

The estimation unit 412 estimates the false acceptance ratio based on the matching score (step S43). The estimation unit 412 can estimate that the false acceptance ratio is small in case the matching score is a small number indicating a low possibility that the features is from the same individual. On the other hand, the estimation unit 412 can estimate that the false acceptance ratio is large in case the matching score is a large number indicating a high possibility that was calculated based on the features of the same individual. In other words, the estimation unit 412 determines whether the matching score is a value that is likely to have been calculated based on the features of the same individual or a value that is unlikely to have been calculated based on the features of the same individual.

In case the false acceptance ratio is small (step S43: Yes) and the living body image for registration was acquired in step 20, the registration unit 416 registers the living body image acquired in a registered biometric information database 421 (step S25-1). The registration unit 416 may register the features extracted from the living body image acquired in the registered biometric information database 421.

In case the false acceptance ratio is small (step S43: Yes) and the living body image for biometric recognition was acquired in step 20, the recognition unit 417 performs the biometric recognition using the living body image acquired and the living body image registered in the registered biometric information database 421 (step S25-2). In case the features extracted from the living body image is registered in the registered biometric information database 421, the recognition unit 417 may perform the biometric recognition using the features extracted from the living body image acquired and the features registered in the registered biometric information

[4-2: Technical effects of the information processing apparatus 4]

The information processing apparatus 4 according to the fourth embodiment can suppress the false acceptance of the imposters due to the quality of the living body images by using the matching score based on the features of the living body image acquired and the transformed the features. That is, the information processing apparatus 4 can determine whether the quality of the single living body images is suitable for use in the biometric recognition. Since the information processing apparatus 4 does not require reference to information registered in a database, etc., it is possible to estimate the false acceptance ratio relatively easily in case of using the living body images for biometric recognition.

In the biometric recognition operations, the process of extracting the features is relatively heavy. Since the information processing apparatus 4 transforms the features extracted from the living body image, the process of extracting the features from the single living body image is performed only once. Therefore, the information processing apparatus 4 is lighter in processing compared to extracting the features from the transformed living body image by transforming the living body image and extracting the features from the living body image.

### 5: Fifth Example Embodiment

Next, the fifth embodiment of the information processing apparatus, information processing method, and recording medium will be described. In the following, the fifth embodiment of the information processing apparatus, information processing method, and recording medium will be described using an information processing apparatus 5 to which the fifth embodiment of the information processing apparatus, information processing method, and recording medium is applied.

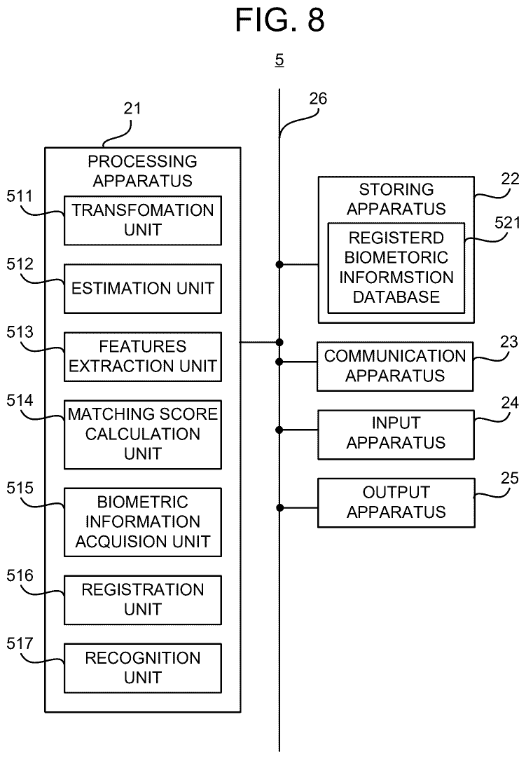

FIG. 8 is a block diagram showing the configuration of the information processing apparatus 5 according to the fifth embodiment. In the fifth embodiment, the operations of a transformation unit 511, an estimation unit 512, a features extraction unit 513, and a matching score calculation unit 514 differ from those of the information processing apparatus 2 according to the second embodiment through the information processing apparatus 4 according to the fourth embodiment.

### [5-1: Information Processing Operations Performed by the Information Processing Apparatus 5]

Referring to FIG. 7, the flow of information processing performed by the information processing apparatus 5 will be described. In the fifth embodiment, the biometric information includes the iris features extracted from the iris image.

As shown in FIG. 7, a biometric information acquisition unit 515 acquires the iris image captured (step S20). The iris image may be an iris image captured for registration. Alternatively, the iris image may be an iris image captured for the iris recognition.

The features extraction unit 513 extracts the iris features from the iris image (step S40). The features extraction unit 513 detects the iris circle from the iris image and extracts the iris features from the iris circle. The iris features may include information indicating changes in feature along the circumferential direction of the iris circle. The transformation unit 511 generates the transformed iris features by transforming the iris features (step S41).

### Example of Generating the Transformed Iris Features

The transformation unit 511 may generate the transformed iris features by inverting the iris circle corresponding to the iris features. The transformation unit 511 may generate the transformed iris features by inverting the iris circle corresponding to the iris features in any direction.

Additionally, the transformation unit 511 may generate the transformed iris features by dividing the iris circle corresponding to the iris features into partial regions using at least one of two or more radii of the iris circle and the circle sharing a center with the iris circle, and then changing the positions of the partial regions. In other words, the transformation unit 511 may generate the transformed iris features by synthesizing partial the features.

The matching score calculation unit calculates the matching score based on the iris features and the transformed iris features (step S42). The estimation unit 512 estimates the false acceptance ratio based on the matching score (step S43). In case the matching score is a value that is unlikely to correspond to the iris features of the same individual, the false acceptance ratio can be estimated to be small. On the other hand, in case the matching score is a value that is likely to have been calculated based on the iris features of the same individual, the false acceptance ratio can be estimated to be large. In other words, the estimation unit 512 determines whether the matching score is a value that is unlikely to have been calculated based on the iris features of the same individual or a value that is likely to have been calculated based on the iris features of the same individual.

In case the false acceptance ratio is small (step S43: Yes) and the iris image for registration was acquired in step 20, a registration unit 516 registers the iris image acquired in a registered biometric information database 521 (step S25-1). The registration unit 516 may register the iris features extracted from the iris image acquired in the registered biometric information database 521.

In case the false acceptance ratio is small (step S43: Yes) and the iris image for biometric recognition was acquired in step 20, a recognition unit 517 performs the biometric recognition using the iris image acquired and the iris image registered in the registered biometric information database 521 (step S25-2). In case the iris features extracted from the iris image is registered in the registered biometric information database 521, the recognition unit 517 may perform the biometric recognition using the iris features extracted from the iris image acquired and the iris features registered in the registered biometric information database 521.

### [5-2: Technical Effects of the Information Processing Apparatus 5]

The information processing apparatus 5 according to the fifth embodiment is capable of estimating the false acceptance ratio in case of registering the iris image and performing the iris recognition. The information processing apparatus 5 is capable of ensuring the quality of the iris information used for iris recognition. In addition, the information processing apparatus 5 is capable of transforming the iris information without losing the information originally possessed.

### 6: Sixth Example Embodiment

Next, the sixth embodiment of the information processing apparatus, information processing method, and recording medium will be described. In the following, the sixth embodiment of the information processing apparatus, information processing method, and recording medium will be described using an information processing apparatus 6 to which the sixth embodiment of the information processing apparatus, information processing method, and recording medium is applied.

### [6-1: Configuration of the Information Processing Apparatus 6]

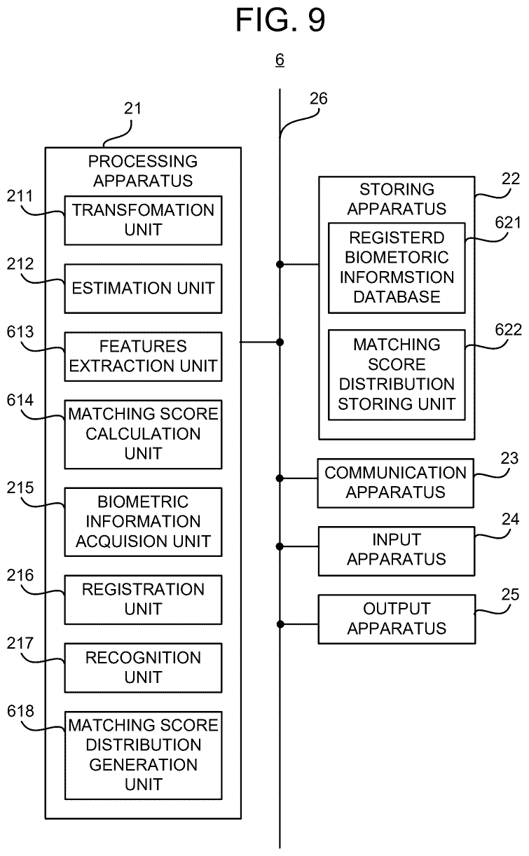

As shown in FIG. 9, the information processing apparatus 6 according to the sixth embodiment includes the processing apparatus 21 and the storing apparatus 22, similar to the information processing apparatus 2 according to the second embodiment through the information processing apparatus 5 according to the fifth embodiment. Furthermore, the information processing apparatus 6 according to the sixth embodiment may also include the communication apparatus 23, the input apparatus 24, and the output apparatus 25 in the same manner as the information processing apparatus 2 according to the second embodiment through the information processing apparatus 5 according to the fifth embodiment. However, the information processing apparatus 6 may omit at least one of the communication apparatus 23, the input apparatus 24, and the output apparatus 25. The information processing apparatus 6 according to the sixth embodiment differs from the information processing apparatus 2 according to the second embodiment through the information processing apparatus 5 according to the fifth embodiments in that a matching score distribution generation unit 618 is further realized within the processing apparatus 21 and a matching score distribution storing unit 622 is further realized within the storing apparatus 22. The other feature of the information processing apparatus 6 may be the same as at least one of the other feature of the information processing apparatus 2 according to the second embodiment through the information processing apparatus 5 according to the fifth embodiment. Therefore, in the following, only the parts that differ from the previously described embodiments will be described in detail, and the other repeated parts will be omitted as appropriate.

### [6-2: Information Processing Operations Performed by the Information Processing Apparatus 6]

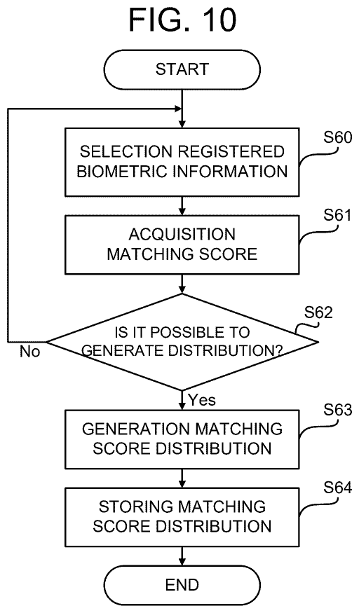

A registered biometric information database 621 stores registered biometric information. As shown in FIG. 10, the matching score distribution generation unit 618 selects any two of the registered biometric information stored in the registered biometric information database 621 (step S60).

The matching score distribution generation unit 618 acquires a matching score calculated based on the selected two registered biometric information (step S61). The matching score distribution generation unit 618 may acquire the matching score calculated by a matching score calculation unit 614 based on any two registered biometric information. In case the registered biometric information stored in the registered biometric information database 621 is the living body image, a features extraction unit 613 extracts the features, and the matching score calculation unit 614 calculates the matching score based on the features extracted by the features extraction unit 613.

The matching score distribution generation unit 618 determines whether a predetermined number of the matching scores have been calculated (step S62). The predetermined number is a number sufficient to generate a matching score distribution. Alternatively, in step S62, it may be determined whether the matching scores have been calculated for all combinations of registered biometric information.

In case a plurality of pieces of registered biometric information is registered for a single individual, the selection operation in step S60 may include selection operations between registered biometric information of the different individuals and selection operations between registered biometric information of the same individual.

In case the matching score calculation operation is complete (step S62: Yes), the matching score distribution generation unit 618 generates the matching score distribution showing the distribution of matching scores calculated (step S63). That is, the matching score distribution generation unit 618 generates the matching score distribution showing the distribution of matching scores calculated based on any two of the registered biometric information registered in the registered biometric information database 621. The matching score distribution generation unit 618 stores the matching score distribution generated in the matching score distribution storing unit 622 (step S64).

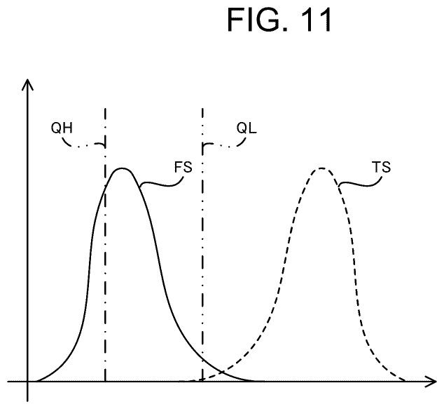

FIG. 11 illustrates an example of the matching score distribution generated by the matching score distribution generation unit 618. The horizontal axis illustrates the magnitude of the matching scores, and the vertical axis illustrates the frequency of occurrence of the magnitudes of the matching scores. The solid line FS may be an example of the matching score distribution based on each piece of the registered biometric information of the different individuals, and the dotted line TS may be an example of the matching score distribution based on each piece of the registered biometric information of the same individual. That is, the matching scores based on each piece of the registered biometric information of the different individuals are smaller than the matching scores based on each piece of the registered biometric information of the same individual.

Furthermore, in case it is possible to calculate matching scores based on each piece of the registered biometric information of the same individual, even if the matching scores are not distinguished between those based on each piece of the registered biometric information of the different individuals and those based on each piece of registered biometric information of the same individual, it can be expected that two peaks will appear in the distribution. Therefore, it can be determined that a relatively small peak of the matching score distribution is the peak of the matching score distribution based on each piece of the registered biometric information of the different individuals, and a relatively large peak of the matching score distribution is the peak of the matching score distribution based on each piece of the registered biometric information of the same individual.

For example, in case the matching score calculated from the biometric information acquired by a biometric information acquisition unit 615 is smaller than a peak of a different individuals matching score distribution, as shown by the dotted line QH, it can be estimated that the biometric information acquired by the biometric information acquisition unit 615 is of a quality that can be used for the biometric recognition. The biometric information for which the matching score shown by the dotted line QH is calculated can be estimated to be biometric information that can be easily distinguished between the same individual and the different individuals. Or, in case the matching score calculated from the biometric information acquired by the biometric information acquisition unit 615 is within the range of a same individual matching score distribution, as shown by the double dotted line QL, the biometric information acquired by the biometric information acquisition unit 615 can be estimated to be of a quality that cannot be used for the biometric recognition.

In case the distribution has two peaks, it can be estimated that the distribution is based on matching scores based on registered biometric information of the different individuals and matching scores based on each piece of the registered biometric information of the same individual. Furthermore, in case the matching scores are distributed in an area smaller than a predetermined area, it can be estimated that the matching scores are based on each piece of the registered biometric information of the different individuals. In case the matching scores are distributed in an area larger than a predetermined area, it can be estimated that the matching scores are based on each piece of the registered biometric information of the same individual. The matching score distribution generation unit 618 may generate at least one of the different individuals matching score distribution and the same individual matching score distribution. For example, in case it is not possible to acquire the matching score distribution based on each piece of the registered biometric information of the different individuals, and it is only possible to acquire the matching score distribution based on each piece of the registered biometric information of the same individual, it is possible to use whether or not the matching score calculated from the biometric information acquired by the biometric information acquisition unit 615 is smaller than the range of the matching score distribution of the same individual as criteria for the determination.

### [6-3: Technical Effects of the Information Processing Apparatus 6]

The information processing apparatus 6 can estimate a value that the matching scores will take in case matching scores are calculated from the registered biometric information of the different individuals using the corresponding recognition means. In addition, it can estimate a value that the matching scores will take in case matching scores are calculated from the registered biometric information of the same individual using the corresponding recognition means.

### 7: Seventh Example Embodiment

Next, the seventh embodiment of the information processing apparatus, information processing method, and recording medium will be described. In the following, the seventh embodiment of the information processing apparatus, information processing method, and recording medium will be described using an information processing apparatus 7 to which the seventh embodiment of the information processing apparatus, information processing method, and recording medium is applied.

### [7-1: Configuration of the Information Processing Apparatus 7]

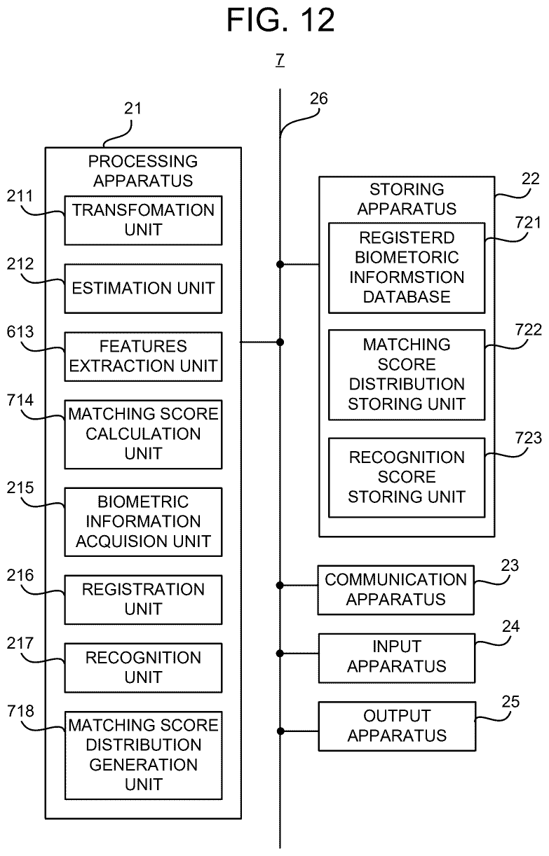

As shown in FIG. 12, the information processing apparatus 7 according to the seventh embodiment is similar to the information processing apparatus 6 according to the sixth embodiment in that it includes the processing apparatus 21 and the storing apparatus 22. Furthermore, the information processing apparatus 7 according to the seventh embodiment may include the communication apparatus 23, the input apparatus 24, and the output apparatus 25 similar to the information processing apparatus 6 according to the sixth embodiment. However, the information processing apparatus 7 may not include at least one of the communication apparatus 23, the input apparatus 24, and the output apparatus 25. The information processing apparatus 7 according to the seventh embodiment differs from the information processing apparatus 6 according to the sixth embodiment in that a recognition score storing unit 723 is further realized within the storing apparatus 22 and the operation of a matching score distribution generation unit 718 is different from that of the information processing apparatus 6 according to the sixth embodiment. The other feature of the information processing apparatus 7 may be the same as the other feature of the information processing apparatus 6 according to the sixth embodiment. Therefore, in the following, only the parts that differ from the embodiments already described will be explained in detail, and the other repeated parts will be omitted as appropriate.

### [7-2: Information Processing Operations Performed by the Information Processing Apparatus 7]

The recognition score calculated in case the biometric information acquired is biometrically authenticated is stored in the recognition score storing unit 723. The recognition score storing unit 723 may be rephrased as storing the recognition scores calculated by a matching score calculation unit 714 in biometric recognition operations performed in the past in the information processing apparatus 7. The recognition score storing unit 723 may store the recognition scores calculated in case the registered biometric information registered in a registered biometric information database 721 and the biometric information acquired for biometric recognition are authenticated. Regardless of the success or failure of the biometric recognition, the recognition scores calculated by the matching score calculation unit 714 may be stored in the recognition score storing unit 723. For example, in case only recognition scores of a specific individual registered in the registration database exceeds the recognition score threshold value, recognition scores with one features registered in the registration database, that exceeded the recognition score threshold value can be estimated as a same individual score, and recognition scores with features other than the one features registered in the registration database can be estimated as a different individuals score. In case it is possible to determine whether an individual is the same individual or the different individuals using means other than the biometric recognition, such as an ID card, the same individual score and the different individuals score can be determined and stored using the results of this determination.

The matching score distribution generation unit 718 generates the matching score distribution showing the distribution of recognition score stored in the recognition score storing unit 723. The distribution of recognition scores in case the biometric recognition is successful can be considered to correspond to the matching score distribution based on each piece of the registered biometric information of the same individual. The distribution of recognition scores in case the biometric recognition fails can be considered to correspond to the matching score distribution based on each piece of the registered biometric information of the different individuals. The matching score distribution generation unit 718 stores the matching score distribution generated in the matching score distribution storage section 722.

In addition, the matching score distribution generation unit 718 may generate the matching score distribution showing the recognition scores stored in the recognition score storing unit 723 and the matching scores calculated by the matching score calculation unit 614 in the sixth embodiment based on any two registered biometric information. The matching score distribution is a distribution determined for each recognition means and may be generated from samples of matching scores calculated by the same recognition means.

### [7-3: Technical Effects of the Information Processing Apparatus 7]

The information processing apparatus 7 can generate the matching score distribution using the history of the results of actual biometric recognition operations performed in the past.

### 8: Eighth Example Embodiment

Next, the eighth embodiment of the information processing apparatus, information processing method, and recording medium will be described. In the following, the eighth embodiment of the information processing apparatus, information processing method, and recording medium will be described using an information processing apparatus 8 to which the eighth embodiment of the information processing apparatus, information processing method, and recording medium is applied.

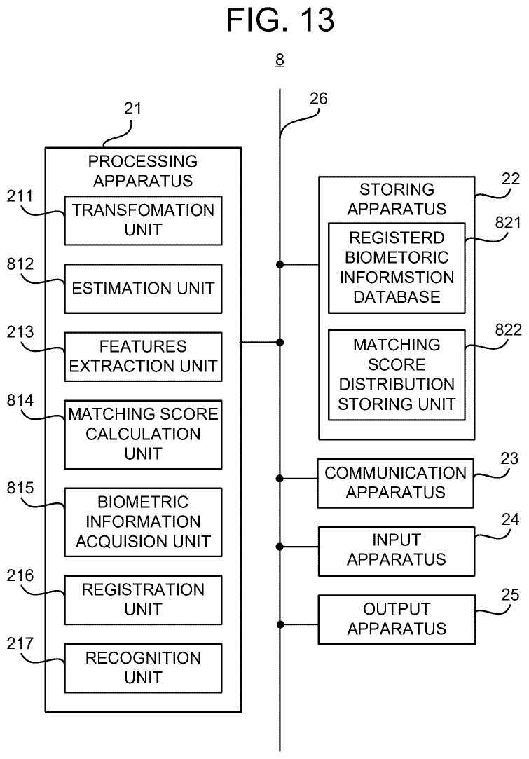

FIG. 13 is a block diagram showing the configuration of the information processing apparatus 8 according to the eighth embodiment. The information processing apparatus 8 according to the eighth embodiment differs from the information processing apparatus 2 according to the second embodiment through the information processing apparatus 7 according to the seventh embodiment in the operation of an estimation unit 812.

A matching score distribution storing unit 822 stores at least one of the matching score distributions generated by the matching score distribution generation unit 618 in the sixth embodiment and the matching score distribution generated by the matching score distribution generation unit 718 in the seventh embodiment. The estimation unit 812 estimates the false acceptance ratio based on the matching score calculated by a matching score calculation unit 814 and the matching score distribution stored in the matching score distribution storing unit 822.

The estimation unit 812 may determine whether to register the biometric information acquired by a biometric information acquisition unit 815 or whether to use it for the biometric recognition by comparing the matching score calculated by the matching score calculation unit 814 with a threshold value of the matching score acquired from the matching score distribution stored in the matching score distribution storing unit 822. The estimation unit 812 may determine that the quality is registrable or usable for biometric recognition in case the matching score is smaller than the threshold value of the matching score acquired from the matching score distribution. In this case, the estimation unit 812 may make the determination using different threshold value depending on whether the biometric information acquired by the biometric information acquisition unit 815 is to be used for registration or biometric recognition.

### [8-2: Technical Effects of the Information Processing Apparatus 8]

The information processing apparatus 8 according to the eighth embodiment can suppress the false acceptance of the imposters due to the quality of biometric information by using the matching score based on the biometric information acquired and the transformed biometric information and the matching score distribution generated in advance.

### 9: Supplementary Note

The following supplementary note is disclosed regarding the embodiments described above.

### [Supplementary Note 1]

An information processing apparatus including:
a transformation unit that transforms biometric information to generate transformed biometric information; and
an estimation unit that estimates a false acceptance ratio of incorrectly accepting imposters in case the biometric information is used for biometric recognition, based on the biometric information and the transformed biometric information.

### [Supplementary Note 2]

The information processing apparatus according to Supplementary Note 1, wherein
the biometric information includes a living body image, and
the estimation unit estimates the false acceptance ratio based on a matching score calculated based on features extracted from the living body image and a transformed features extracted from a transformed living body image generated by transforming the living body image.

### [Supplementary Note 3]

The information processing apparatus according to Supplementary Note 1 or 2, wherein
the biometric information includes an iris image, and
the estimation unit estimates the false acceptance ratio based on a matching score calculated based on iris features extracted from the iris image and a transformed iris features extracted from a transformed iris image generated by transforming the iris image.

### [Supplementary Note 4]

The information processing apparatus according to Supplementary Note 1, wherein
the biometric information includes features extracted from a living body image,
the transformation unit transforms the features to generate transformed features, and
the estimation unit estimates the false acceptance ratio based on a matching score calculated based on the features and the transformed features.

### [Supplementary Note 5]

The information processing apparatus according to Supplementary Note 1 or 4, wherein
the biometric information includes iris features extracted from an iris image,
the transformation unit transforms the iris features to generate transformed iris features, and
the estimation unit estimates the false acceptance ratio based on a recognition score calculated based on the iris features and the transformed iris features.

### [Supplementary Note 6]

The information processing apparatus according to Supplementary Note 3 or 5, wherein
the biometric information includes iris information of an iris region, and
the transformation unit generates transformed iris information by inverting the iris information, or by dividing the iris information into pieces of partial information using at least one of two or more radii of the iris region and a circle sharing a center with the iris region, and changing position of the pieces of partial information.

### [Supplementary Note 7]

The information processing apparatus according to Supplementary Note 2, further including
a generating unit that generates a matching score distribution indicating a distribution of matching scores calculated based on any two of registered biometric information registered in a registration database.

### [Supplementary Note 8]

The information processing apparatus according to Supplementary Note 2, further including:
a recognition score storage unit that stores recognition scores calculated in case the biometric recognition is performed on biometric information acquired; and
a generation unit that generates a matching score distribution indicating a distribution of the recognition scores stored in the recognition score storage unit.

### [Supplementary Note 9]

The information processing apparatus according to Supplementary Note 7 or 8, wherein
the estimation unit estimates the false acceptance ratio based on the matching score calculated and the matching score distribution generated by the generation unit.

### [Supplementary Note 10]

An information processing method including:
transforming biometric information to generate transformed biometric information; and
estimating a false acceptance ratio of incorrectly accepting imposters in case the biometric information is used for biometric recognition, based on the biometric information and the transformed biometric information.

### [Supplementary Note 11]

A recording medium on which a computer program is stored, the computer program being configured to allow a computer to execute an information processing method including:
transforming biometric information to generate transformed biometric information; and
estimating a false acceptance ratio of incorrectly accepting imposters in case the biometric information is used for biometric recognition, based on the biometric information and the transformed biometric information.

This disclosure may be changed as appropriate within the scope that does not contradict the technical idea that can be read from the claims and the entire description. The information processing apparatus, information processing method, and recording medium with such changes are also included in the technical idea of this disclosure.

### DESCRIPTION OF REFERENCE CODES

1, 2, 3, 4, 5, 6, 7, 8 information processing apparatus
11, 211, 311, 411, 511 transformation unit
12, 212, 312, 412, 512, 812 estimation unit
213, 313, 413, 513, 613 features extraction unit
214, 314, 414, 514, 614, 714, 814 matching score calculation unit
215, 315, 415, 515, 615, 815 biometric information acquisition unit
216, 316, 416, 516 registration unit
217, 317, 417, 517 recognition unit
221, 321, 421, 521, 621, 721, 821 registered biometric information database
618, 718 matching score distribution generation unit
622, 722, 822 matching score distribution storing unit
723 recognition score storing unit

What is claimed is:

1. An information processing apparatus comprising:
at least one memory storing instructions; and
at least one processor that is configured to execute the instructions to:
transform biometric information to generate transformed biometric information; and
estimate a false acceptance ratio of incorrectly accepting imposters in case the biometric information is used for biometric recognition, based on the biometric information and the transformed biometric information.

2. The information processing apparatus according to claim 1, wherein
the biometric information includes a living body image, and
the at least one processor that is configured to execute the instructions to estimate the false acceptance ratio based on a matching score calculated based on features extracted from the living body image and a transformed features extracted from a transformed living body image generated by transforming the living body image.

3. The information processing apparatus according to claim 1, wherein
the biometric information includes an iris image, and
the at least one processor that is configured to execute the instructions to estimate the false acceptance ratio based on a matching score calculated based on iris features extracted from the iris image and a transformed iris features extracted from a transformed iris image generated by transforming the iris image.

4. The information processing apparatus according to claim 1, wherein
the biometric information includes features extracted from a living body image, and
the at least one processor that is configured to execute the instructions to:
transform the features to generate transformed features; and
estimate the false acceptance ratio based on a matching score calculated based on the features and the transformed features.

5. The information processing apparatus according to claim 1, wherein
the biometric information includes iris features extracted from an iris image, and
the at least one processor that is configured to execute the instructions to:
transform the iris features to generate transformed iris features; and
estimate the false acceptance ratio based on a recognition score calculated based on the iris features and the transformed iris features.

6. The information processing apparatus according to claim 3, wherein
the biometric information includes iris information of an iris region, and
the at least one processor that is configured to generate transformed iris information by inverting the iris information, or by dividing the iris information into pieces of partial information using at least one of two or more radii of the iris region and a circle sharing a center with the iris region, and changing position of the pieces of partial information.

7. The information processing apparatus according to claim 2, wherein
the at least one processor that is configured to generate a matching score distribution indicating a distribution of a plurality of matching scores calculated based on any two of registered biometric information registered in a registration database.

8. The information processing apparatus according to claim 2, wherein the at least one processor that is configured to:
store recognition scores calculated in case the biometric recognition is performed on biometric information acquired, in the at least one memory; and
generate a matching score distribution indicating a distribution of the recognition scores stored in the at least one memory.

9. The information processing apparatus according to claim 7, wherein
the at least one processor that is configured to estimate the false acceptance ratio based on the matching score calculated and the matching score distribution generated.

10. An information processing method comprising:
transforming biometric information to generate transformed biometric information; and
estimating a false acceptance ratio of incorrectly accepting imposters in case the biometric information is used for biometric recognition, based on the biometric information and the transformed biometric information.

11. A non-transitory recording medium on which a computer program is stored, the computer program being configured to allow a computer to execute an information processing method comprising:
transforming biometric information to generate transformed biometric information; and
estimating a false acceptance ratio of incorrectly accepting imposters in case the biometric information is used for biometric recognition, based on the biometric information and the transformed biometric information.
